(19) United States
(12) Patent Application Publication
(10) Pub. No.: US 2003/0009686 A1
(43) Pub. Date: Jan. 9, 2003

(54) Computer-implemented method for denying unauthorized access to data in a computer data storage medium

(76) Inventor: Yu-Te Wu, Chia-Yi City (TW)

Correspondence Address: MARGER, JOHNSON & McCOLLOM, PC, 1030 SW Morrison Street, Portland, OR, 97205, US

(21) Appl. No.: 09/898,426

(22) Filed: Jul. 3, 2001

(51) Int. Cl. G06F 12/14

(52) U.S. Cl. 713/200

(57) ABSTRACT

In a method for denying unauthorized access to data stored in a computer data storage medium of a computer, a product serial number of the storage medium is read and processed to generate a locking signal that is recorded when setting a status of the storage medium to a locked state. When a disarm input is supplied by the user of the computer, the disarm input is converted into a converted signal that is compared with the locking signal. The user is allowed access to the storage medium when a match is detected between the converted and locking signals, and is denied access to the same when otherwise.

### BACKGROUND OF THE INVENTION

1. Field of the Invention

The invention relates to computer data storage mediums, more particularly to a computer-implemented method for denying unauthorized access to data stored in a computer data storage medium.

2. Description of the Related Art

Due to the conveniences offered by computers, an increasing number of confidential information is currently being stored in an electronic format in computer data storage mediums. As such, there is thus an urgent need to guard against unauthorized access to confidential data stored in computer data storage mediums.

### SUMMARY OF THE INVENTION

Therefore, the object of the present invention is to provide a computer-implemented method for denying unauthorized access to data stored in a computer data storage medium.

According to the present invention, a computer-implemented method for denying unauthorized access to data stored in a computer data storage medium of a computer comprises the steps of:

reading a product serial number of the storage medium;

processing the product serial number to generate a locking signal;

recording the locking signal, and setting a status of the storage medium to a locked state;

allowing the user of the computer to supply a disarm input;

converting the disarm input into a converted signal;

comparing the converted signal with the locking signal;

releasing the storage medium from the locked state so as to allow the user to access the data stored in the storage medium when a match is detected between the converted and locking signals; and

maintaining the locked state of the storage medium so as to deny the user access to the data stored in the storage medium when a match is not detected between the converted and locking signals.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of a computer that implements the method of the present invention; and

FIG. 2 is a flowchart illustrating the preferred embodiment of the computer-implemented method of this invention.

### DETAILED DESCRIPTION OF THE PREFERRED EMBODIMENT

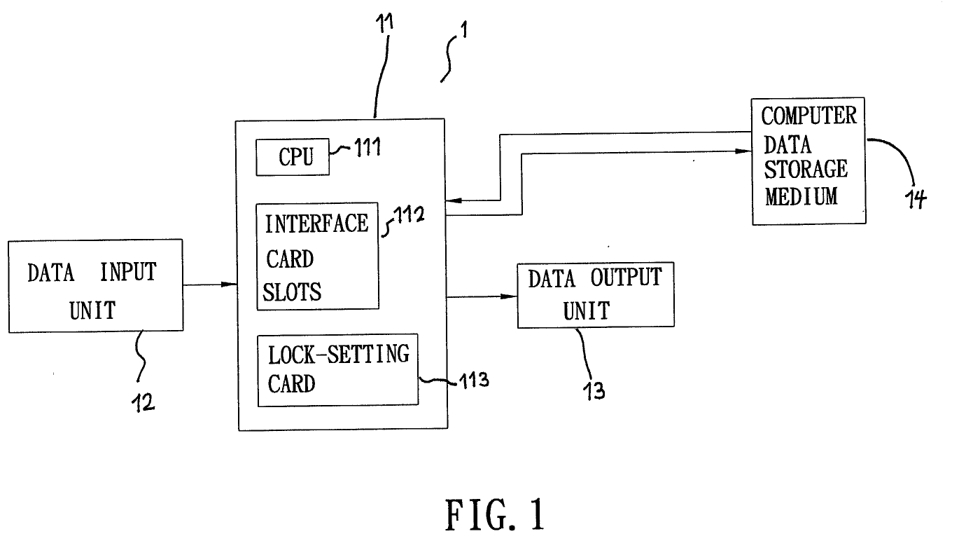

Referring to FIG. 1, the method of this invention is to be implemented by a computer 1 for controlling access to data stored in a computer data storage medium 14, such as a hard disk, a floppy disk, a Zip disk, etc. As is known in the art, the computer data storage medium 14 is allotted with a product serial number that is unique thereto during the manufacture of the same. The computer 1 is conventional in construction, and includes a processing device 11, a data input unit 12, and a data output unit 13. The processing device 11, in the form of a mainboard, has a central processing unit 111 mounted thereon. The processing device 11 is further provided with a plurality of interface card slots 112, such as ISA, PCI and AGP card slots.

In a preferred embodiment of the method of this invention, a lock setting card 113 is mounted on and is connected to the processing device 11. The lock setting card 113 is configured to set a locked status of the storage medium 14 for controlling the connection between the processing device 11 and the storage medium 14, and is further configured with first and second conversion routines and a decision routine. The first conversion routine is used to process the product serial number of the storage medium 14 so as to generate a locking signal. The second conversion routine is used to convert a disarm input supplied by the user into a converted signal. The decision routine is used to compare the converted signal with the locking signal. The first and second conversion routines can be implemented using simple logic calculations or complex signal transformation routines.

When the user wishes to access the storage medium 14, an access command will be inputted via the data input unit 12 and will be received by the processing device 11. The CPU 111 transmits the access command to the lock setting card 113 and, in response to the access command, the lock setting card 113 issues a verify message to the user via the data output unit 13. The verify message requests the user to supply the disarm input. Subsequently, the disarm input from the user is provided to the lock setting card 113 and is converted into a corresponding converted signal. The converted signal thus obtained is then compared with the locking signal. Whether or not the user is authorized to access the storage medium 14 depends on the result of the comparison.

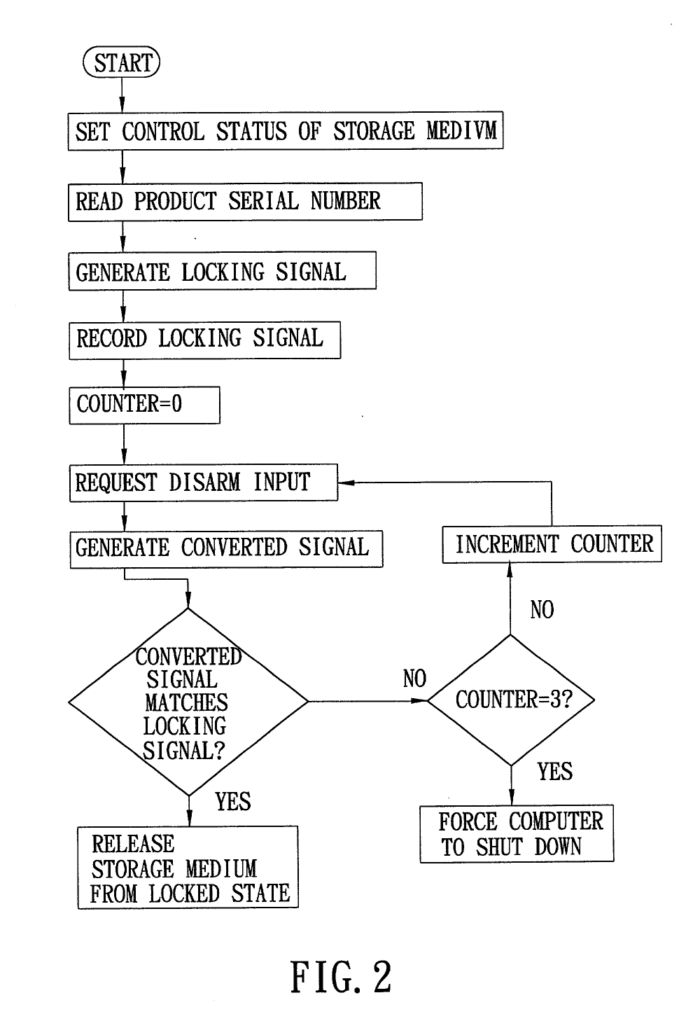

With further reference to FIG. 2, when the computer 1 is activated, the lock setting card 113 operates to set the control status of the storage medium 14 such that verification is performed before the user can access the storage medium 14. At this time, the product serial number of the storage medium 14 is read, and the locking signal is generated from the product serial number with the use of the first conversion routine of the lock setting card 113. The locking signal is recorded, and the storage medium 14 is in a locked state at this time.

Thereafter, when the user issues an access command for accessing the data stored in the storage medium 14, a counter of the lock setting card 113 will be set to 0, and a verify message will be provided to the user so as to request the disarm input from the user. The disarm input supplied by the user will be converted into a corresponding converted signal with the use of the second conversion routine of the lock setting card 113, and the converted signal is compared with the locking signal. When a match is detected, the storage medium 14 is released from the locked state, and the user can access the data stored in the storage medium 14 at this time. However, when a match is not detected, the counter is incremented by one unit, and the verify message is once again provided to the user. When the content of the counter reaches a value of three, indicating that the user has failed three consecutive times in providing the correct disarm input, the computer 1 is forced to shut down.

In another embodiment of the method of the present invention, the control status setting, the first and second conversion routines, and the decision routine of the lock setting card of the previous embodiment are implemented using firmware that is stored in a hard disk that serves as the computer data storage medium 14.

In yet another embodiment of the method of the present invention, the control status setting, the first and second conversion routines, and the decision routine of the lock setting card of the first preferred embodiment are implemented using firmware that is stored in the processing device 11.

It should be noted that the disarm input is not limited to an alphanumeric input, and may be in the form of a non-alphanumeric input, such as a voice input, a fingerprint input, or a magnetic strip input.

By virtue of the method of this invention, unauthorized access of the data stored in a computer data storage medium can be prevented to ensure the security and integrity of the same.

In the method of the present invention, the product serial number of the storage medium is used to generate the locking signal, and the disarm input from the user is converted into the converted signal that is compared with the locking signal. Therefore, in the case the user forgets the correct disarm input, the computer can be sent to the supplier for releasing the storage medium from the locked state by using the conversion routines to process the product serial number. As such, the integrity of the data stored in the storage medium can be maintained, and continued use of the storage medium is possible without the need to format the latter.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A computer-implemented method for denying unauthorized access to data stored in a computer data storage medium of a computer, said computer-implemented method comprising:
reading a product serial number of the storage medium;
processing the product serial number to generate a locking signal;
recording the locking signal, and setting a status of the storage medium to a locked state;
allowing the user of the computer to supply a disarm input;
converting the disarm input into a converted signal;
comparing the converted signal with the locking signal;
releasing the storage medium from the locked state so as to allow the user to access the data stored in the storage medium when a match is detected between the converted and locking signals; and
maintaining the locked state of the storage medium so as to deny the user access to the data stored in the storage medium when a match is not detected between the converted and locking signals.

2. The computer-implemented method of claim 1, further comprising the step of forcing the computer to shut down when a match is not detected between the converted and locking signals.

3. The computer-implemented method of claim 1, wherein the disarm input is a non-alphanumeric input.
